(19) United States
(12) Patent Application Publication
(10) Pub. No.: US 2004/0006496 A1
(43) Pub. Date: Jan. 8, 2004

(54) Electronic waiting room

(76) Inventor: Christian Nickerson, West Wind, NJ (US)

Correspondence Address: Gibson, Dunn & Crutcher LLP, Suite 4100, 1801 California Street, Denver, CO, 80202, US

(21) Appl. No.: 10/360,556

(22) Filed: Feb. 7, 2003

Related U.S. Application Data
(60) Provisional application No. 60/355,227, filed on Feb. 7, 2002.

(51) Int. Cl. G06F 17/60

(52) U.S. Cl. 705/3

(57) ABSTRACT

A system and method for monitoring and managing, in real-time, interactions between a healthcare provider, a patient and an insurer is disclosed. The system and method comprises of a virtual or electronic waiting room. Management and monitoring of patient interactions and transactions is achieved by storing attributes associated with a patient and linking these attributes to a virtual representation of the patient, which may be accessed and manipulated via the electronic or virtual waiting room.

System and method for electronically monitoring and managing, in real-time, interactions between a healthcare provider, a patient and an insurer. This application claims priority from U.S. Provisional Application No. 60/355,227 filed on Feb. 7, 2002.

### BACKGROUND OF THE INVENTION

1. Field of the Invention

The present invention relates to healthcare provider-patient-insurer interactions and more specifically to electronically managing and monitoring, in real-time, the information necessary for and the processing of such interactions.

2. Description of the Related Art

Currently, health care providers (hereinafter referred to as the “Provider” or “Providers”), Patients (hereinafter referred to as the “Patient” or “Patients”) and Insurers (hereinafter referred to as the “Insurer”) need to exchange various pieces of paperwork in connection with any procedures performed or to be performed on the Patient and the insurance coverage for these proposed or completed procedures. Current systems for managing such transactions, which may be transacted either wholly or partially on paper, encounter the following problems: (a) recording and submission of accurate paperwork is necessary or transactions cannot be processed and must be resubmitted; (b) a particular request may require the submission of additional information that is in the custody of one of the parties—Patient, Provider or Insurer—but is not instantaneously available to all of the parties; (c) at the time of a Patient visit, the Provider may not know the status of a request for a particular procedure and, as a result, may risk performing a procedure that is not covered by insurance; (d) record keeping is unduly complex with each entity—Provider, Patient and Insurer—often keeping separate and incompatible records; (e) Providers and Patients have to fill out repetitive paperwork; (f) real-time management or oversight of Patient-Provider transactions is difficult; and (g) generally, real-time transactions between the Provider and Insurer are not possible or at best occur via telephone or facsimile.

Both Providers and Patients would benefit greatly from a real-time claims submission method that also provides an easy to use system for submitting insurance requests, receiving virtually immediate responses from Insurers and storing necessary information concerning Provider-Patient and Provider-Insurer transactions in a consistent form. What is needed, then, is a system and method for organizing the various Patients that are covered by a particular Provider, pooling necessary information from both the Provider and Insurer concerning these Patients, completing required information in a consistent manner, submitting coverage claims in connection with such Patients via the Internet, making Patient information available to multiple Provider employees, providing an interface for secure communications between a Provider and Insurer concerning a Patient and allowing Patients access to information concerning Provider-Insurer transactions.

### BRIEF SUMMARY OF THE INVENTION

The following invention addresses the above-mentioned needs in the art by providing a Provider with a work management tool that allows the Provider to effectively manage and monitor a Patient's visit and any associated transactions in an organized and paperless manner. This tool can track a Patient from the time a Patient enters the Provider's office and insurance eligibility is verified through to the finalization of the Patient's coverage claim and applicable treatment with a few easy clicks. Similarly, a “Patient portal” is provided that provides the Patient with a summary of all activity relating to their requests for coverage and the status of those requests in a secure manner.

The Electronic Waiting Room includes the following key functions: (a) add Patient to Electronic Waiting Room; (b) remove Patient from waiting Room; (c) add work item(s) to Patient; (d) delete work item(s) from Patient; (e) save work item information; (f) sort Electronic Waiting Room; (g) change location of Electronic Waiting Room; (h) communicate work item request to Insurer; (i) receive communications relating to work items; (j) process and receive reports summarizing requests to Insurer and any responses from the Insurer; and (k) a Patient portal whereby a Patient can view insurance and procedure status. Utilizing these functions, any Patient of the Provider's staff who has been given access can track a Patient's status or add work items—even if the staff member is not in the same office as the one visited by the Patient. Also, by using standard work item formats, various information concerning a Patient can be filled in electronically by the Electronic Waiting Room system and, more importantly, the Electronic Waiting Room system can evaluate work items and prompt corrections and additions as necessary. Furthermore, by incorporating the inventions described in the Legacy Data Conversion process as described in Appendix 1 and the System and Method for Managing Internet Transactions as described in Appendix 2, the Electronic Waiting Room can provide a Provider with real-time status of insurance coverage.

### BRIEF DESCRIPTION OF THE FIGURES

FIG. 1 is a flow diagram illustrating the creation of a patient profile for use in the Electronic Waiting Room.

FIG. 2 is a screen shot illustrating one method of organizing an Electronic Waiting Room interface.

FIG. 3 is a flow diagram illustrating how the Electronic Waiting Room may be used to process a Patient transaction.

FIG. 4 is a flow diagram illustrating how the Electronic Waiting Room may be used to manage Internet transactions with an Insurer.

FIG. 5 is a flow diagram illustrating how any employee of the Provider may access the Electronic Waiting Room and view patient status or modify or commence a transaction.

FIG. 6 is a flow diagram illustrating how the Electronic Waiting Room can be used to store information while a Patient transaction proceeds.

FIG. 7 illustrates how a Patient may access aspects of their profile remotely.

### DETAILED DESCRIPTION OF THE INVENTION

Reference will now be made in detail to the construction and operation of preferred implementations of the present invention illustrated in the accompanying drawings. In those drawings like elements and operations are designated with the same reference numbers when possible.

The following description of the preferred implementations of the present invention is only exemplary of the invention. The present invention is not limited to these implementations, but may be realized by other implementations.

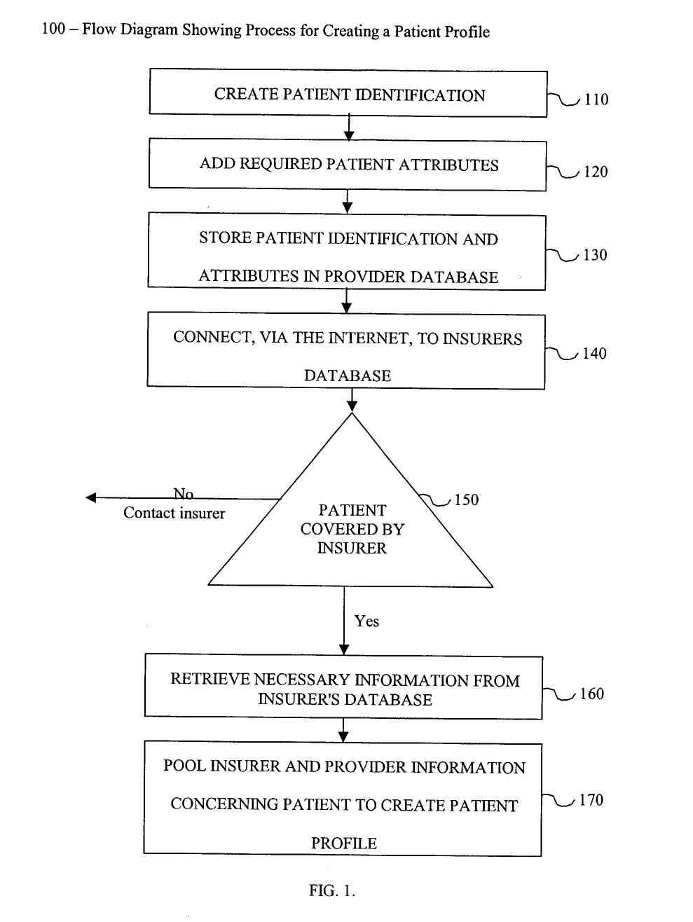

FIG. 1 shows how, in a preferred embodiment of the invention, information from the Provider's Database 130 is pooled with information from the Insurer's Database 140 to create a Patient Profile 170. This is a superior profile to those currently available to Providers because it contains information that the Insurer has selected as necessary for Insurer-Provider transactions concerning the patient.

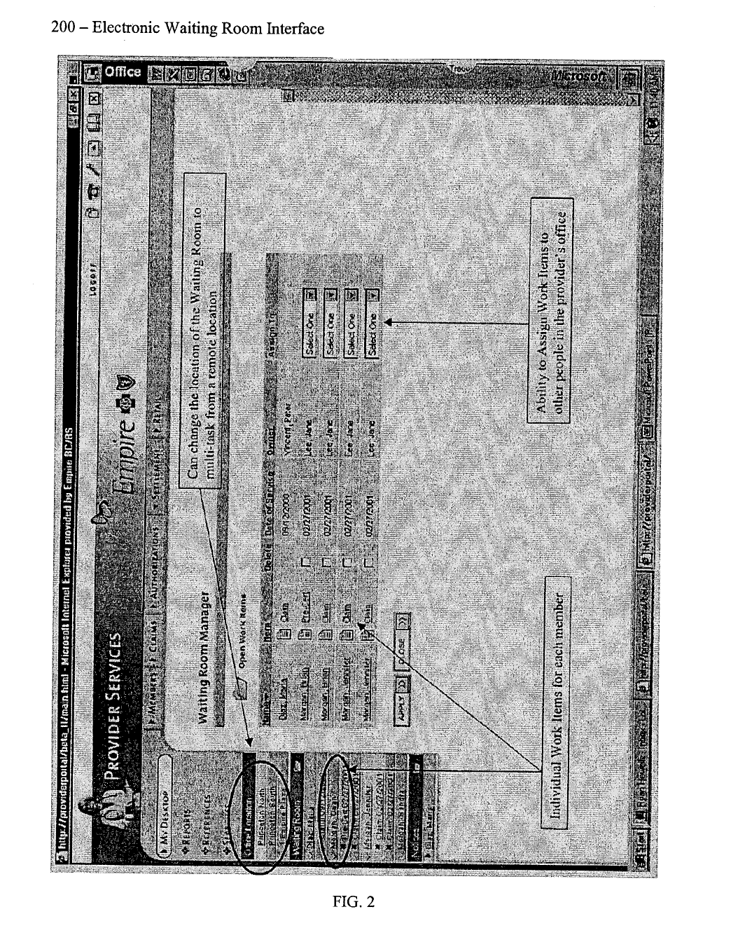

The Electronic Waiting Room system and method commences when the Provider adds a new Patient to its system. One of the functions comprising the Electronic Waiting Room is a virtual waiting room, which is designated as such, and may reside as an electronic space, page or dedicated area on a Provider's system. FIG. 2 illustrates how an Electronic Waiting Room interface 200 may be organized on the Provider's system. The system and method may use an Electronic Waiting Room interface 200 or any other embodiment to represent a waiting room, including the creation of a virtual waiting room. In a preferred embodiment of the invention, when a Provider accesses their computer system or network a visual icon establishes the existence of the Electronic Waiting Room interface 200 and when this icon is clicked on the Provider sees the virtual waiting room or Electronic Waiting Room interface 200. The Electronic Waiting Room interface may be a web page maintained by the Provider or other electronic space on the Provider's system or network.

A new member may be added to the Provider's Electronic Waiting Room system by creating an Identifier 110 and entering various, necessary attributes 120. The Identifier 110 and attributes 120 are stored in the Provider's Database 130. Using the inventions described in the patent applications attached as Appendix 1 and Appendix 2, incorporated by reference herein, the Provider can access the Insurer's Database 140, via the Internet, without leaving the Electronic Waiting Room function, and confirm that the Patient is covered by the appropriate Insurer 150. If the system does not show that the Patient is covered by the appropriate Insurer 150 manual intervention is necessary and the Provider may contact the Insurer for coverage approval. If, however, insurance coverage is confirmed, information selected by the Insurer and stored on the Insurer's Database 140 is added, via the Internet, to the Patient's attributes 120 stored on the Provider's Database 130. In this way, necessary information concerning the Patient in the custody of the Provider 120 and Insurer 140 is pooled to create a complete and accurate Patient Profile 150 for Provider-Insurer purposes. This method is superior to the state of the art because it provides the Provider, in real-time, with additional information concerning the Patient that can be used to determine appropriate treatment and available insurance coverage. Furthermore, this complete Patient profile increases the probability of successful future Provider-Insurer transactions.

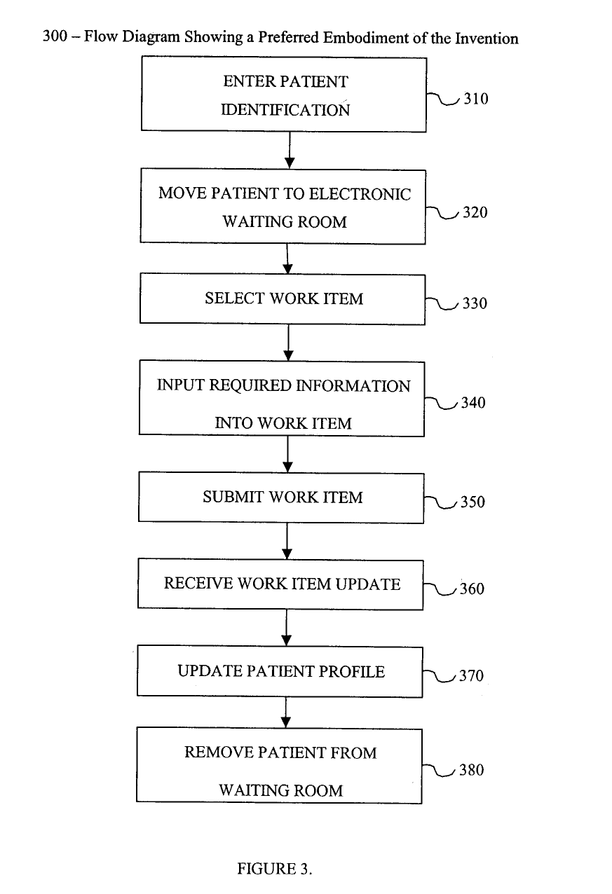

FIG. 3 illustrates how a Provider-Patient transaction occurs using the Electronic Waiting Room. Once a Patient Profile 150 has been created and stored in the Provider's Databases 130, the Provider can select the Patient's information by entering the Patient's Identification 110—i.e., the Patient's social security number or insurance number—or via a Patient search. Once the Provider selects a Patient, an electronic representation of the Patient appears—i.e., a name or insurance number—on the Provider's portal and this representation can be moved by the Provider into the Electronic Waiting Room 320. In the preferred embodiment of the invention, the Patient's representation is an icon containing the Patient's Identification that can be dragged over and into the Electronic Waiting Room feature on the Provider's portal. The Patient icon is linked to a page that includes various attributes of the Patient that may include personally identifiable information as well as information relating to their prior medical history 170.

Once a Patient is added to the Electronic Waiting Room 320, the representation of the Patient and the linked Patient attributes are accessible to any employee of the Provider who has been given access to the Electronic Waiting Room. In the preferred embodiment of the system, a receptionist enters a Patient's identification 310 and moves the electronic representation of the Patient to the Electronic Waiting Room 320. At this point, the Patient representation and linked information is available to any of the Provider's employees who have an access code. In a preferred embodiment of the invention, employees can be given different access levels—i.e., a nurse's access may be limited to retrieving a Patient's medical history or an office manager's access may be limited to a Patient's insurance information. In a preferred embodiment of the invention, the Provider's offices contain numerous computers with access to the Provider's system and the Electronic Waiting Room or staff members are provided with handheld units linked to the Provider's computer system.

By accessing the Electronic Waiting Room 320, the Provider can select a Patient from the Waiting Room and pull up information concerning the Patient or select a ‘work item’ 330 (‘work item’ is used to describe any transaction—i.e., creating a claim or a pre-certification), for example, a nurse may access the Patient profile to look at the Patient's medical history, a doctor may also access the work history and may also add a diagnosis and proposed treatment as a Work Item, or an administrative employee may add a request for insurance as a Work Item. Similarly, an administrator can navigate to a centralized Patient home page that allows the Provider to edit the stored Patient profile. In this way, any new information provided by a Patient can be added to the Patient profile.

In a preferred embodiment of the invention, Work Items can be pulled down from a menu 330, for example, a doctor may complete a “diagnosis” Work Item or an administrator may complete a ‘request for coverage for treatment’ Work Item. In this way, the Provider can use standard forms and necessary information in the Patient's profile can be automatically inputted into the forms removing the redundancy of repeatedly entering the same Patient information into different forms. Also, standard forms can have prompts so that, for example, when a Patient's required treatment is described on the form the treatment prompt ensures that the treatment description meets an Insurer's approved treatment descriptions. In this way, errors, lack of required information etc are less likely to occur and Provider-Insurer transactions are less likely to be rejected as requiring more or Insurer compliant information. Furthermore, by using the Patient Profile 170, information obtained from the Insurer can be added to the standard forms and, consequently, the resulting Work Items 340 are likely to be more accurate and to meet Insurer requirements when submitted 350.

Once the Provider selects the Patient 's representation and moves it to the Electronic Waiting Room 320, he or she can then add a Work Item for that particular Patient 330. The Provider has the option of entering information about the Work Item 340 or performing other work within the portal and then returning to the original Work Item and completing the Work Item; the information for a Work Item is saved for a Patient until it is either deleted or completed. Once the Provider completes the information on the Work Item 340, they can submit the item 350 and it disappears from the Electronic Waiting Room. Optionally, as discussed previously, different Providers (or staff Patients of the Providers) may have rights to perform different transactions with respect to the Patient, for example, a bookkeeper could submit a claim for payment on a procedure while only a nurse could actually create an entry for the new procedure. The various realm of actions that a particularly employee of the Provider may perform may be defined by the Provider, by the Patient, or by the Insurer.

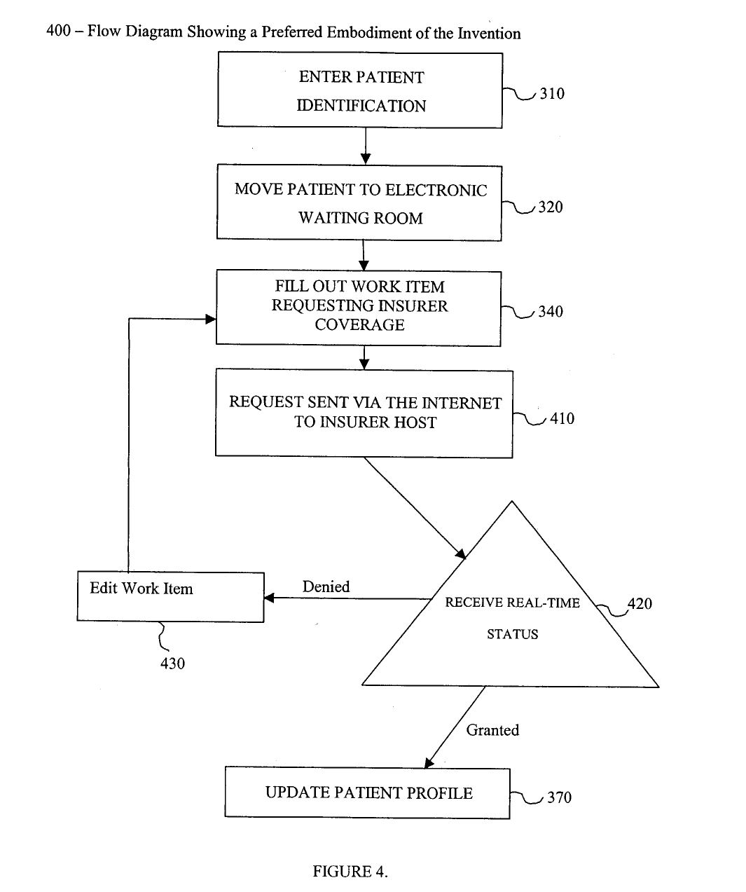

Once a Work Item has been submitted 350, the Provider receives a real-time update of the Work Item status 360. The Work Item update 360 may show the change in the Patient Profile submitted by the Provider or it may show the status of a request for insurance coverage (See FIG. 4). Once the Work Item has been submitted, the Patient Profile 170 is updated to show the relevant changes 370. In this way, all Provider-Patient transactions are recorded in the Patient Profile 170 in real-time.

Finally, once the Provider-Patient transaction is completed, the Patient is removed from the Electronic Waiting Room 380.

FIG. 4 shows a preferred embodiment of the Electronic Waiting Room invention. In this embodiment the inventions disclosed in the attached patent applications, Appendix 1 and Appendix 2, are incorporated by reference. By incorporating these inventions, it is possible for a Provider to complete a Work Item requesting insurance coverage 410 from an Insurer and receive in real time, via the Internet, a response from the Insurer 420. If the real-time response establishes that coverage was granted then the Patient Profile 170 is updated and the Provider can perform treatment with the knowledge that the Insurer will cover the treatment. If, however, coverage is denied 330, the Provider can edit the request 310 and resubmit the request 310. If after editing, the request is once again denied then manual intervention by the Provider is necessary.

In this way, not only does the Electronic Waiting Room provide a management tool for Patient transactions it also provides a method for seamlessly and in real-time requesting and receiving insurance coverage adjudications.

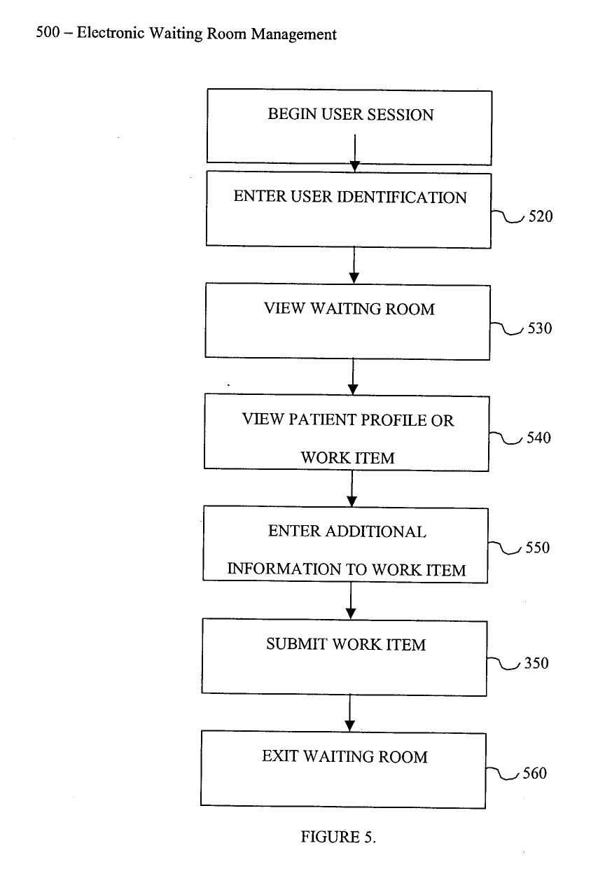

FIG. 5 illustrates how the Electronic Waiting Room provides accessible, real-time information to any member of a Provider's staff whatever the staff member's location. The staff member (hereinafter referred to as the “User”) begins a session 510 by navigating to the Provider's portal. The User then enters his or her identification and if the identification is valid, the User is given access to the Electronic Waiting Room 530. The User can then view the Patient Profile or any Work Items that have not been completed 540. In this way, the Patient's status is available to any member of the Provider's staff with access to the Electronic Waiting Room and Work Items can be viewed and edited by multiple staff members 550. Once a User has viewed/edited the Work Item, it is then submitted in the normal manner 350 and the User exits the Electronic Waiting Room 560.

This functionality described in FIG. 5, allows the Provider to assign/reassign Work Items to any staff member in the office with access to the Electronic Waiting Room. In a preferred embodiment, this can be done by selecting the Electronic Waiting Room manager icon and assigning the Work Item to someone else in the office. The new owner will receive a message explaining that the Work Item was reassigned to them. If the Provider desires to take ownership of a particular Work Item, they can select the Work Item and then select ‘Take ownership’. A message will be sent to the original owner explaining someone else now owns the Work Item.

Furthermore, when Providers have multiple offices, the Provider and Patient portals can serve as a “virtual” office manager. For example, if a Provider wishes to know whether a Patient has come for an appointment, the Provider can switch ‘locations’ by selecting a different location above the Waiting Room. This allows a Provider to monitor Work Items in another Provider office and provide remote support in helping to close out various Work Items.

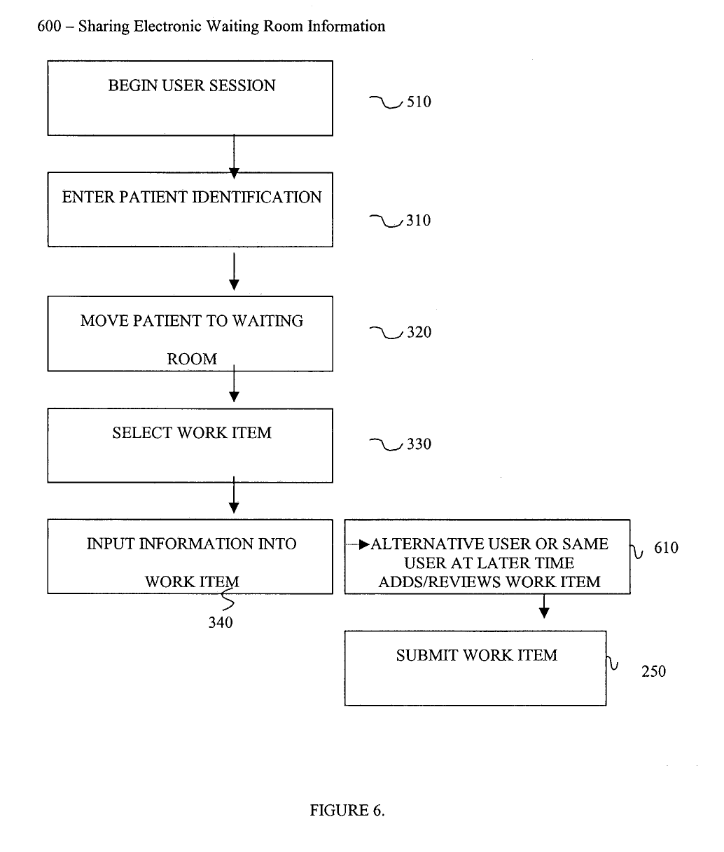

FIG. 6 illustrates how the Electronic Waiting Room allows the retention of Work Items. The User begins a session 510, selects a Patient 310, moves the Patient to the Electronic Waiting Room 320, selects a Work Item 330 and begins inputting the necessary information 340. At this point, the User is free to handle other matters or gather more information since the Work Item and inputted information is stored with the Patient's Profile 170. In this way, a User can simply return and finish a Work Item later or leave the incomplete Work Item to be completed by another User 610. As a result, the Electronic Waiting Room provides a simple management tool that reduces paperwork and stores incomplete transactions. In a preferred embodiment of the invention, a reminder function alerts Users to incomplete Work Items.

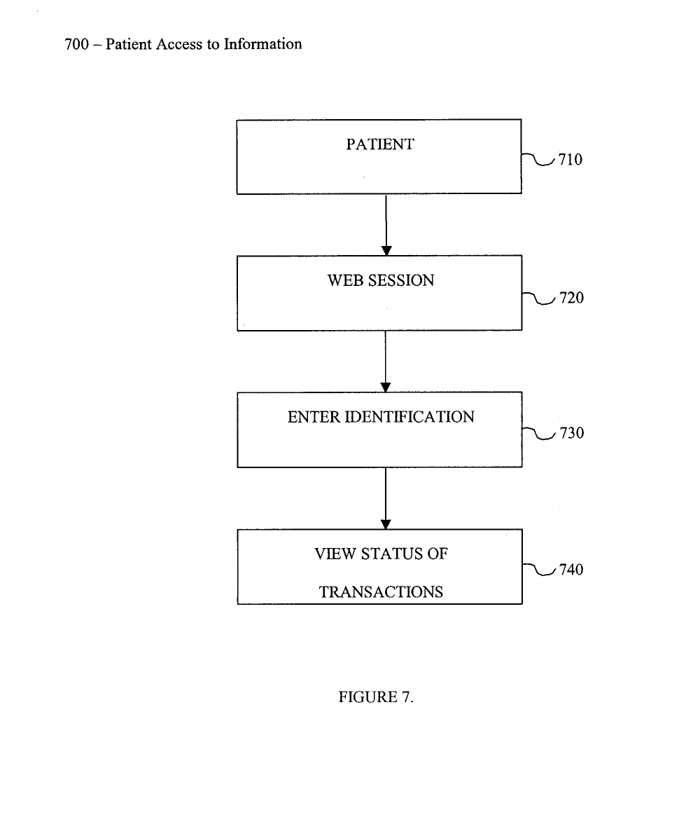

FIG. 7 illustrates how the invention may be used by a Patient to view the status of transactions. The Patient 710 begins a Web Session 720 and navigates to the Provider's portal. The Patient enters their Identification 730 and if it is valid the Patient can view the status of Work Items and attributes of their profile 740 that the Provider has selected for Patient viewing.

Similarly, the Electronic Waiting Room can include “inline” messaging system as a means for communicating with Patients. For example, if a particular Patient is scheduled for a particular procedure, that Patient can be notified when that procedure has been pre-certified. By using an “inline” messaging system through a browser, this information can be securely communicated to the Patient without the need for additional software or training, such as is often required with secure electronic mail correspondence.

The Electronic waiting Room has many advantages over current state of the art Provider-Patient transaction methods, including:

Flexibility to save information within a ‘form’ before submission

Ability to assign specific ‘tasks’ to other people in the Provider office virtually.

Online, interoffice notification capability to assign and reassign Work Items to other people in the office.

Workflow integration throughout the office to monitor workload of each of the individuals within a specific office location.

Remote Provider office support to complete Work Items in other office locations.

Ability to take ownership of uncompleted Work Items to expedite payment processing in a specific office location.

Secure communications to Patients through use of a portal interface.

Increased efficiency resulting from reduced Patient contacts concerning claim status etc.

The foregoing description of the preferred embodiments of the invention has been presented for the purposes of illustration and description. The descriptions of the header structures should not be limited to the embodiments described. For these reasons, this description is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A system and method for managing and monitoring, in real-time, interactions between a healthcare provider and a patient comprising the step of:
maintaining a virtual Electronic Waiting Room associated with the healthcare provider.

2. The system and method of claim 1, further comprising making the virtual Electronic Waiting Room accessible to the healthcare provider's employees.

3. A system and method for managing and monitoring, in real-time, interactions between a healthcare provider and a patient comprising the steps of:
a. storing one or more attributes relating to the patient;
b. storing an identification for the patient;
c. creating an electronic representation of the patient, which is linked to said Patient's attributes, in the Electronic Waiting Room when the patient's identification is entered into the office Provider's system at the beginning of a Patient's visit.

4. The system and method of claim 2, wherein said Patient's attributes are updated at the end of the Patient visit to include all information regarding the visit.

5. The system and method of claim 2, further comprising adding work items to the Patient's representation in the Electronic Waiting Room as necessary during the visit.

6. The system and method of claim 2, further comprising a Patient portal through which a Patient can, via the Internet, view a summary of the status of his or her transactions with the office Provider and/or an Insurer.
